(19) United States
(12) Patent Application Publication
(10) Pub. No.: US 2026/0045171 A1
(43) Pub. Date: Feb. 12, 2026

(54) INTERACTIVE BLOCK, INTERACTIVE DEVICE, AND METHOD FOR PROVIDING INTERACTIVE CONTENT

(71) Applicant: ROBOCARE CO., LTD., Seongnam-si (KR)

(72) Inventors: Min Jae LEE, Seongnam-si (KR); Ga Young CHOI, Yongin-si (KR); Yu Jeong CHOI, Gwangju-si (KR)

(21) Appl. No.: 19/363,701

(22) Filed: Oct. 21, 2025

Related U.S. Application Data
(63) Continuation of application No. PCT/KR2023/018411, filed on Nov. 16, 2023.

(30) Foreign Application Priority Data
Jun. 1, 2023 (KR) 10-2023-0070837

(51) Int. Cl. G09B 5/06; A63H 33/04; A63H 33/26

(52) U.S. Cl. CPC G09B 5/06; A63H 33/042; A63H 33/26

(57) ABSTRACT

An interactive block according to an embodiment of the present disclosure includes: at least one sidewall part; a detachable coupling part disposed within the sidewall part and configured to supply a coupling force allowing attachment to and detachment from another interactive block; and an electrode part disposed within the sidewall part and configured to form capacitive coupling using the sidewall part as a dielectric, in order to detect coupling with the other interactive block.

### DESCRIPTION

### TECHNICAL FIELD

The present disclosure relates to an interactive block, an interactive device, and a method for providing interactive content.

### BACKGROUND

Tools that connect or combine a plurality of unit blocks to create various shapes have been developed in various ways as educational tools or toys for fostering children’s sensory and motor functions as well as creativity.

With the integration and miniaturization of electrical components, unit blocks have been equipped with power supplies, displays, and the like. Thus, it is possible to provide various types of sensory information to users. Also, there have been developed tools which, using sensors and communication components mounted on unit blocks, are capable of detecting input states according to a user’s manipulation or arrangement and outputting corresponding results to provide interactive content.

Meanwhile, such tools have been used not only for children but also for adults, including the elderly, for a wide range of purposes such as calculation, cognitive and manipulation training, rehabilitation therapy, functional or technical learning, and the provision of immersive content.

These interactive tools, while combining various electrical and electronic components to expand their functions, are fundamentally required to offer freedom and durability that allow users to manipulate and arrange them in various ways, as well as lightness and convenience.

### DISCLOSURE OF THE INVENTION

### PROBLEMS TO BE SOLVED BY THE INVENTION

The present disclosure is conceived to provide an interactive device configured to detect a coupling state between a plurality of interactive blocks via capacitive coupling.

Also, the present disclosure is conceived to provide an interactive device that is operable to transmit and receive signals through a configuration provided within a coupling surface and configured to detect a coupling state between a plurality of interactive blocks.

Further, the present disclosure is conceived to provide a method for providing interactive content, including detecting a coupling state between a plurality of interactive blocks, and guiding and evaluating various user manipulations and arrangements based on the detection.

However, the problems to be solved by the present disclosure are not limited to the above-described problems. There may be other problems to be solved by the present disclosure.

### MEANS FOR SOLVING THE PROBLEMS

As a means for achieving the above-described technical problems, an aspect of the present disclosure provides an interactive block, including: at least one sidewall part; a detachable coupling part disposed within the sidewall part and configured to supply a coupling force allowing attachment to and detachment from another interactive block; and an electrode part disposed within the sidewall part and configured to form capacitive coupling using the sidewall part as a dielectric, in order to detect coupling with the other interactive block.

Another aspect of the present disclosure provides an interactive device, including: a base; and a plurality of interactive blocks detachably attachable to the base, and each of the interactive blocks includes: at least one sidewall part; a detachable coupling part disposed within the sidewall part and configured to supply a coupling force allowing attachment to and detachment from another interactive block; and an electrode part disposed within the sidewall part and configured to form capacitive coupling using the sidewall part as a dielectric, in order to detect coupling with the other interactive block.

Yet another aspect of the present disclosure provides a method for providing interactive content that uses a plurality of interactive blocks each including an electrode part disposed within a sidewall part and configured to form capacitive coupling using the sidewall part between the electrode parts as a dielectric when the interactive blocks are positioned adjacent to each other, and the method includes: a process of guiding a user to arrange the plurality of interactive blocks in initial positions; a process of verifying, based on the formation of capacitive coupling, whether the plurality of interactive blocks is arranged in the initial positions; a process of presenting a task to the user to select at least one of the plurality of interactive blocks and change its position; and a process of determining, based on the formation of capacitive coupling, whether a result of the user’s change of position matches a correct arrangement.

The above-described aspects are provided by way of illustration only and should not be construed as liming the present disclosure. Besides the above-described embodiments, there may be additional embodiments described in the accompanying drawings and the detailed description.

### EFFECTS OF THE INVENTION

According to any one of the above-described means for solving the problems of the present disclosure, it is possible to accurately recognize a coupling state between a plurality of interactive blocks via capacitive coupling formed using a sidewall part as at least a portion of a dielectric.

Also, signals can be transmitted and received between the plurality of interactive blocks through electrode parts spaced apart from each other with the sidewall part interposed therebetween. Thus, the functions can be implemented without additional processing, such as installing sensors through the sidewall parts. Accordingly, the durability and assemblability of the blocks can be improved, and the components can be simplified.

Furthermore, according to a method for providing interactive content of the present disclosure, it is possible to intuitively and accurately implement cognitive, calculation, and manipulation training for users including elderly users by using detection results regarding coupling state or coupling direction between interactive blocks.

### BRIEF DESCRIPTION OF THE DRAWINGS

FIG. 1 is a perspective view of an interactive device according to an embodiment of the present disclosure.

FIG. 2 is a perspective view of a base of the interactive device according to an embodiment of the present disclosure.

FIG. 3 and FIG. 4 are perspective views of an interactive block of the interactive device according to an embodiment of the present disclosure.

FIG. 5 is a diagram illustrating a process of transmitting, receiving, and restoring signals between interactive blocks of the interactive device according to an embodiment of the present disclosure.

FIG. 6 is a flowchart showing a method for providing interactive content according to another embodiment of the present disclosure.

FIG. 7A to FIG. 8B are exemplary diagrams of guidance screens showing processes of the method for providing interactive content according to yet another embodiment of the present disclosure.

### BEST MODE FOR CARRYING OUT THE INVENTION

Hereinafter, example embodiments will be described in detail with reference to the accompanying drawings so that the present disclosure may be readily implemented by those skilled in the art. However, it is to be noted that the present disclosure is not limited to the example embodiments but can be embodied in various other ways. In the drawings, parts irrelevant to the description are omitted for the clarity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Throughout this document, the term “unit” may refer to a unit implemented by hardware, software, and/or a combination thereof. As examples only, one unit may be implemented by two or more pieces of hardware or two or more units may be implemented by one piece of hardware.

Throughout this document, a part of an operation or function described as being carried out by a terminal or device may be implemented or executed by a device connected to the terminal or device. Likewise, a part of an operation or function described as being implemented or executed by a device may be so implemented or executed by a terminal or device connected to the device.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality.

Processors are considered processing circuitry or circuitry as they include transistors and other circuitry therein. In the disclosure, the circuitry, units, or means are hardware that carry out or are programmed to perform the recited functionality.

The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Hereinafter, embodiments of the present disclosure will be described in detail with reference to the accompanying drawings.

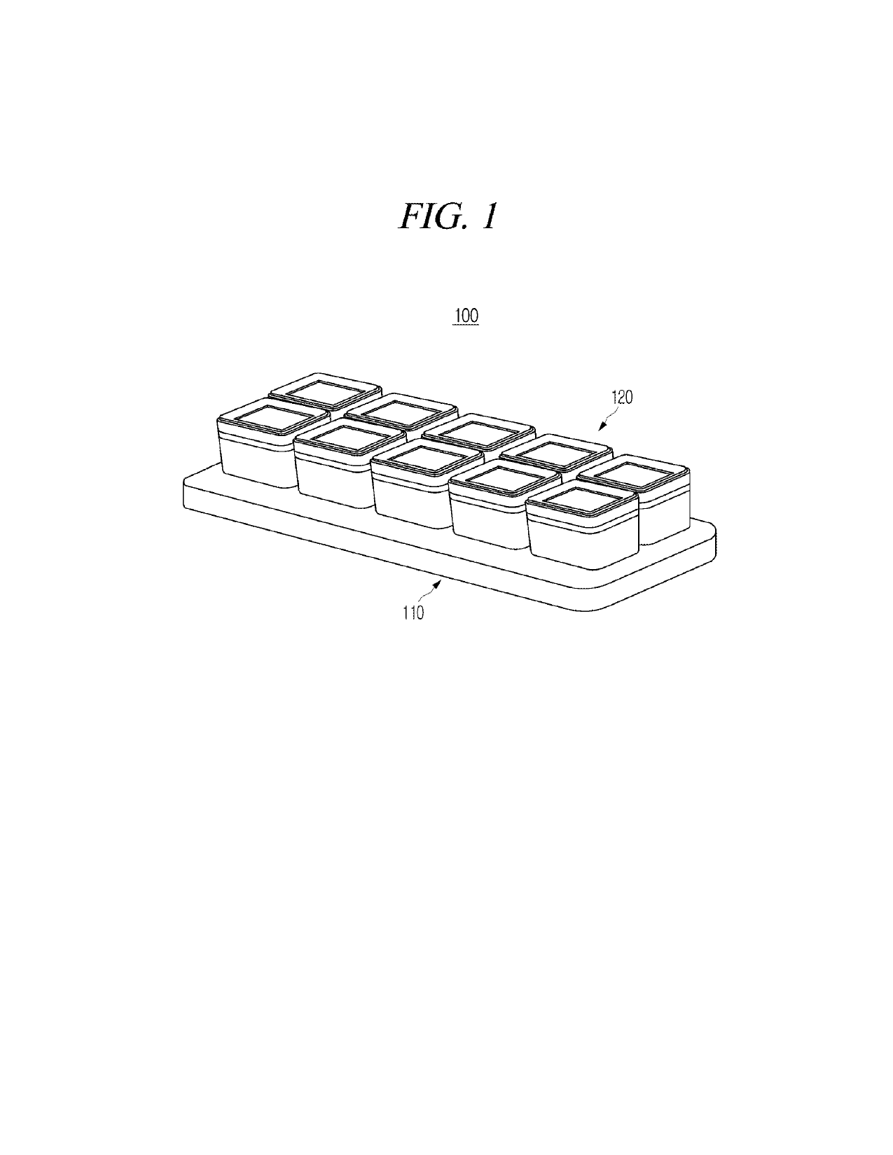

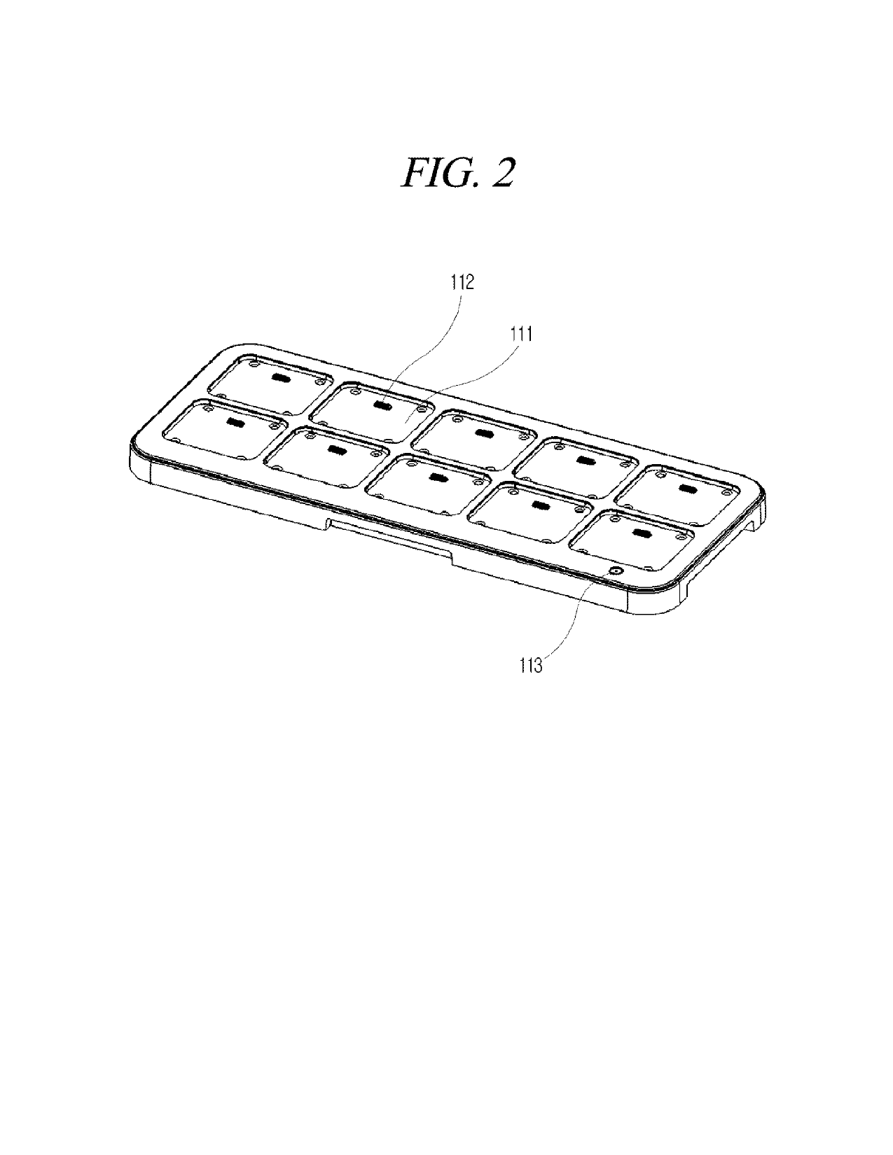

FIG. 1 is a perspective view of an interactive device according to an embodiment of the present disclosure, and FIG. 2 is a perspective view of a base of the interactive device according to an embodiment of the present disclosure.

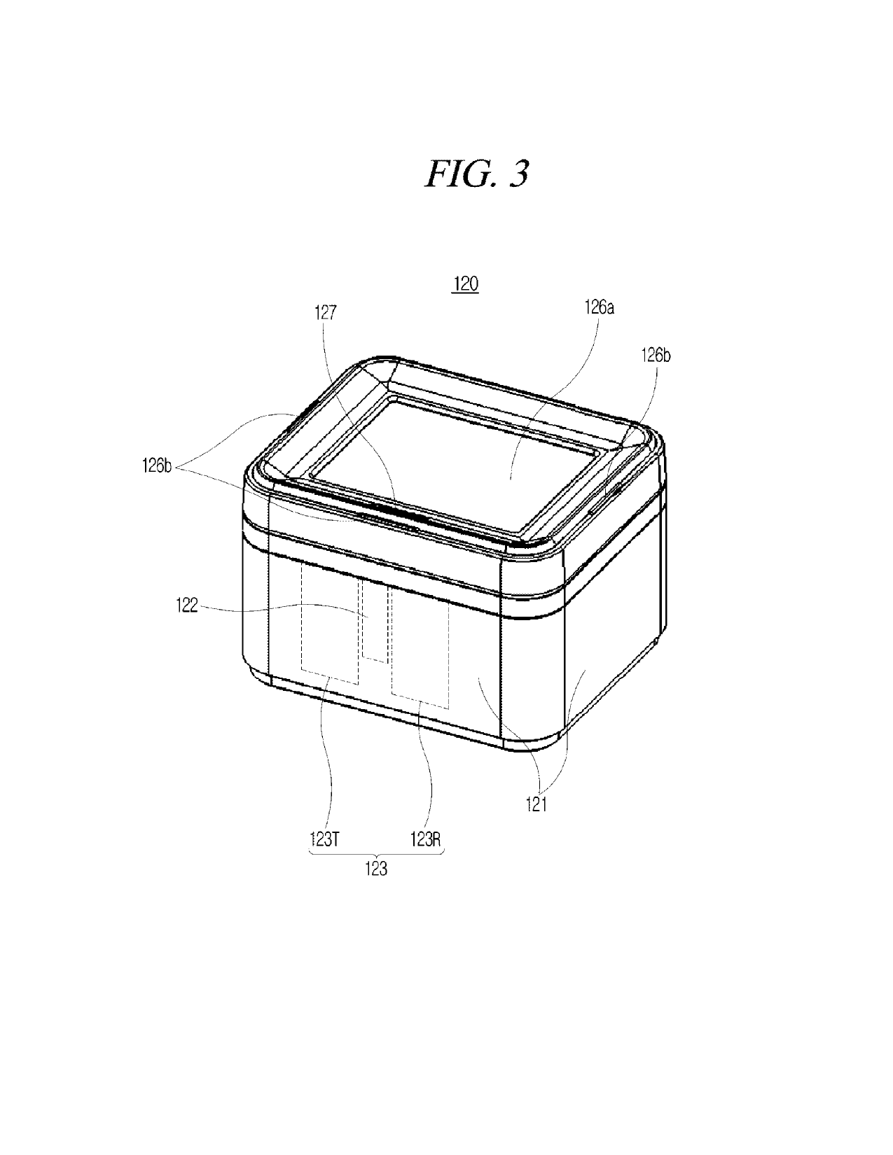

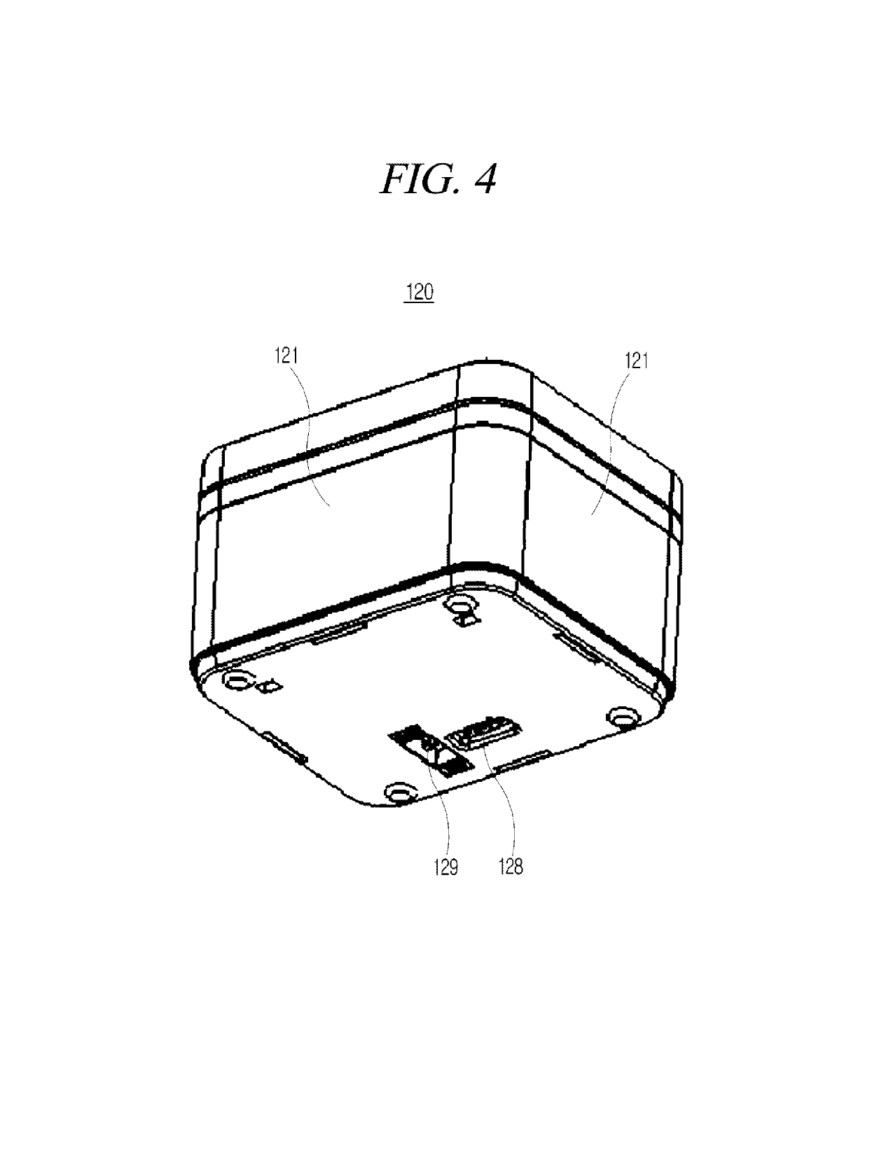

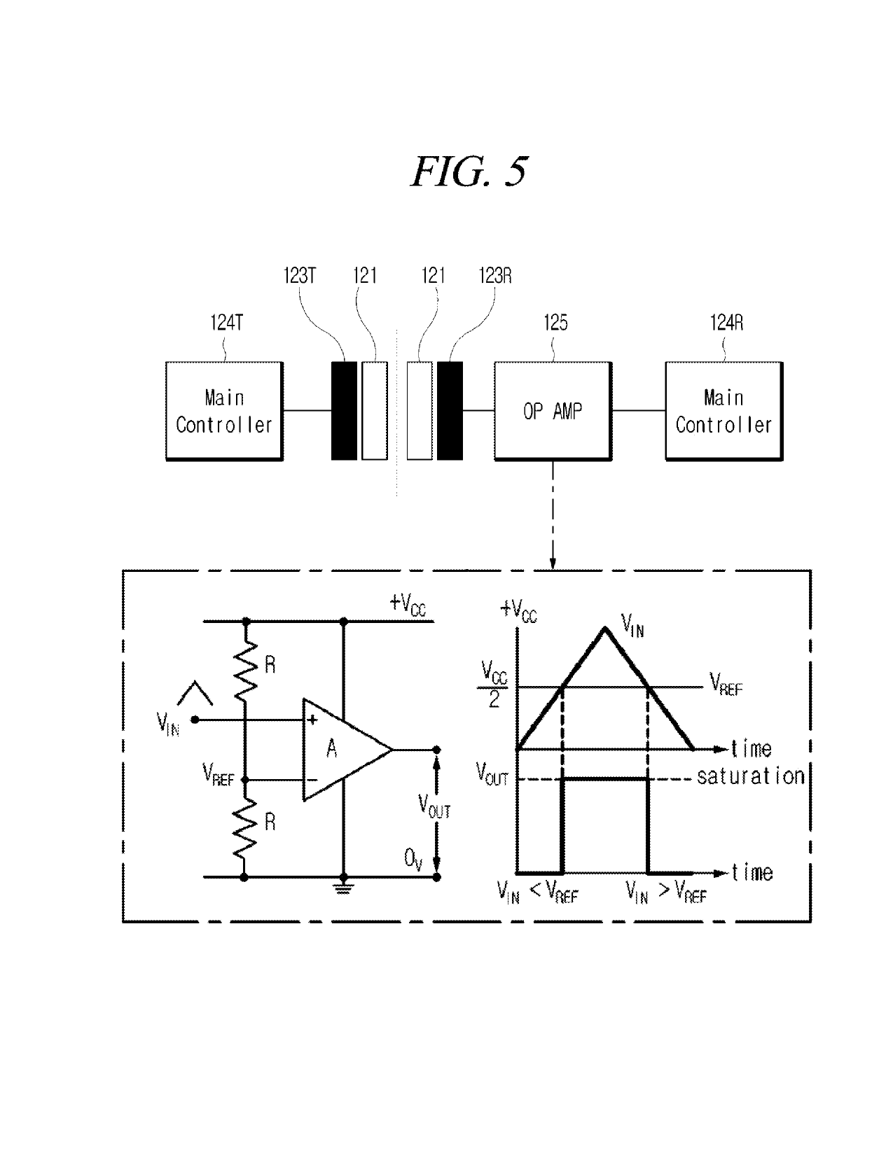

FIG. 3 and FIG. 4 are perspective views of an interactive block of the interactive device according to an embodiment of the present disclosure. FIG. 5 is a diagram illustrating a process of transmitting, receiving, and restoring signals between interactive blocks of the interactive device according to an embodiment of the present disclosure.

Referring to FIG. 1, an interactive device 100 according to an embodiment of the present disclosure may include a base 110 and a plurality of interactive blocks 120. The interactive blocks 120 of the interactive device 100 in the present embodiment may be provided to a user so as to be combined or arranged in any mutual positional relationship. According to the present embodiment, the base 110 may be provided to collect the interactive blocks 120 and mount them thereon. In the present embodiment, the interactive blocks 120 may be configured to detect a coupling state and a coupling position between them, and to display related information to the user.

Referring to FIG. 2, the base 110 may be equipped with a block mounting unit 111 and a power port 112. The block mounting unit 111 may have a groove shape on an upper surface of the base 110 in which each of the plurality of interactive blocks 120 can be mounted. The block mounting unit 111 may supply a coupling force allowing attachment to and detachment from the interactive block 120. For example, a magnet such as a neodymium magnet may be provided therein.

The power port 112 may be provided in each block mounting unit 111. The power port 112 may be electrically connected to the interactive block 120 (specifically, a port 128 described later) mounted in the block mounting unit 111, and supply power from the base 110 to the interactive block 120. Thus, it is possible to charge each interactive block 120.

The base 110 may receive external power in a wired manner, and may further include a power lamp 113 for indicating an operating state.

Referring to FIG. 3, the interactive block 120 of the present embodiment may have a substantially cubic shape. That is, four side surfaces (front, rear, left, and right surfaces) may be formed between an upper surface and a lower surface.

The interactive block 120 may include a sidewall part 121, a detachable coupling part 122, and an electrode part 123. The sidewall part 121 may be formed on each of the four side surfaces and arranged to face in the front, rear, left, and right directions, and may be coupled to the sidewall part 121 of another interactive block 120 in an abutting manner.

The detachable coupling part 122 may be disposed within the sidewall part 121, and may supply a coupling force allowing attachment to and detachment from another interactive block 120. Similar to the block mounting unit 111 described above, the detachable coupling part 122 may be made of a magnet such as a neodymium magnet.

The electrode part 123 is configured to detect or identify coupling between the interactive blocks 120 whose sidewall parts 121 are in contact with each other. The electrode part 123 may be disposed within the sidewall part 121. The electrode part 123 may form capacitive coupling using the sidewall part 121 as a dielectric. More specifically, when a pair of the electrode parts 123, respectively provided within one interactive block 120 and another interactive block 120, are disposed spaced apart from each other with the sidewall parts 121 interposed therebetween, capacitive coupling may be formed.

Specifically, each electrode part 123 may include a transmission unit 123T and a reception unit 123R. As shown in FIG. 3, the transmission unit 123T and the reception unit 123R may be arranged in pairs for each sidewall part 121 of the interactive block 120. In this case, the transmission units 123T and the reception units 123R may be arranged alternately on opposite-facing sidewall parts 121. Accordingly, when the sidewall parts 121 of two interactive blocks 120 are in contact with each other, the transmission unit 123T of one interactive block 120 and the reception unit 123R of the other interactive block 120 may be disposed with the two sidewall parts 121 interposed therebetween.

Hereinafter, a process of detecting coupling between two interactive blocks 120 via capacitive coupling will be described with reference to FIG. 5.

As shown in FIG. 5, the interactive block 120 of the present embodiment may further include controllers 124T and 124R electrically connected to the transmission unit 123T and reception unit 123R, respectively, and a detection unit 125 for generating and restoring a signal, or determining a coupling state.

In a transmission interactive block, the transmission unit 123T may transmit a square wave signal generated according to a predetermined protocol. Herein, the square wave signal may be generated by the controller 124T of the transmission interactive block and transferred to the transmission unit 123T. The square wave signal may represent a unique identification number (ID) of the transmission interactive block and an identification value specifying one of the four sidewall parts (e.g., front, rear, left, and right sides) of the interactive block, according to the predetermined protocol.

When the transmission interactive block and a reception interactive block are adjacent and capacitive coupling is formed, the reception unit 123R of the reception interactive block may receive a triangular wave signal via the capacitive coupling.

The detection unit 125 connected to the reception unit 123R may be configured to restore the triangular wave signal. Specifically, the detection unit 125 may be configured as a Schmitt trigger circuit or an operational amplifier (OP AMP) circuit to restore the triangular wave signal to a square wave signal or a signal close to a square wave.

As shown in FIG. 5, when the detection unit 125 is configured as an OP AMP circuit, a triangular wave VIN received from the reception unit 123R and a reference voltage VREF may be input, and a square wave signal VOUT in a restored form may be output.

The restored signal may be interpreted by the controller 124R of the reception interactive block according to the predetermined protocol. Accordingly, the reception interactive block may receive information regarding coupling with the transmission interactive block, i.e., the unique ID of the transmission interactive block and the identification value specifying the coupled sidewall part.

Meanwhile, referring again to FIG. 3, the interactive block 120 of the present embodiment may further include a display unit 126a, a light-emitting unit 126b, and a speaker unit 127.

The display unit 126a may be formed to cover at least a portion of the upper surface. The display unit 126a may output visual information indicating a power on/off state or coupling with another interactive block 120. The visual information may include instructions for guiding the user to perform a manipulation, and a numeral, color, or image for specifying the interactive block 120 or distinguishing it from other interactive blocks 120.

The display unit 126a may also be configured to detect touch input from the user. For example, the display unit 126a may be configured as a capacitive or resistive touch panel. The display unit 126a may be configured to output visual information and to receive touch input from the user for playing content such as games.

Further, through touch input to the display unit 126a, the user may operate to turn the interactive block 120 on or off, or to access a settings menu of the interactive block 120. The settings menu may provide, for example, various parameter settings, or operational settings or testing of various components including the light-emitting unit 126b.

Similar to the display unit 126a, the light-emitting unit 126b may be configured to output visual information. Specifically, the light-emitting unit 126b may be formed along a corner portion between the display unit 126a and the sidewall part 121, and may be provided at each of the four corner portions of the cube. Each light-emitting unit 126b may be configured as a light-emitting diode (LED), and may directly indicate whether another interactive block 120 has been coupled to the sidewall part 121 located below the corresponding corner portion. For example, the light-emitting unit 126b may be electrically connected in a circuit with at least one of the electrode part 123, the detection unit 125, and the controllers 124T and 124.

The speaker unit 127 may be disposed on the upper surface of the interactive block 120 and may output voice information. Similar to the display unit 126a, the speaker unit 127 may output voice information indicating a power on/off state, a coupling state with another interactive block 120, instructions for guiding the user to perform a manipulation, and information for specifying the interactive block 120.

Referring to FIG. 4, the interactive block 120 of the present embodiment may further include the port 128 and a power switch 129. The port 128 may be formed on the lower surface of the interactive block 120 to be electrically connected to the power port 112 of the base 110. Through the port 128, power may be supplied from the base 110 to charge a battery disposed within the interactive block 120.

In the present embodiment, the power switch 129 may be provided on the lower surface of the interactive block 120. The power switch 129 may be configured as a toggle switch or button switch that can be turned on or off by user manipulation.

Meanwhile, a motion sensor (not shown) may be mounted within the interactive block 120 of the present embodiment. The motion sensor may be provided on a controller or PCB within the interactive block 120. The motion sensor may be configured to detect at least one change in position and angle of the interactive block 120. Specifically, the motion sensor may be configured to detect acceleration and/or angular velocity, and may detect when the user shakes the interactive block 120 or rapidly moves/stops it. Information input from the motion sensor may be used as input information in the content provided by the interactive block 120.

Further, a vibration motor (not shown) may be mounted within the interactive block 120 of the present embodiment. For example, the vibration motor may be provided near the port 128 at a lower portion of the interactive block 120. In the settings menu, the strength or number of vibrations, and duration may be set. Also, the on/off or activation time of the vibration function may be configured. The vibration motor may output vibration to the user to provide information such as notifications or feedback in various types of content.

According to the above-described interactive device 100, it is possible to accurately recognize a coupling state between the plurality of interactive blocks 120 via capacitive coupling. In particular, the formation of capacitive coupling can be detected for each of the plurality of sidewall parts 121, and a coupling surface (sidewall part) as well as a unique ID of the coupled interactive block 120 can be accurately recognized by interpreting transmitted and received signals according to the protocol.

Furthermore, signals can be transmitted and received between the plurality of interactive blocks 120 through the electrode parts 123 disposed within the interactive blocks 120 and spaced apart from each other with the sidewall part 121 interposed therebetween. Thus, the functions can be implemented without additional processing, such as installing sensors through the sidewall parts 121. Accordingly, the durability and assemblability of the blocks can be improved, and the components can be simplified.

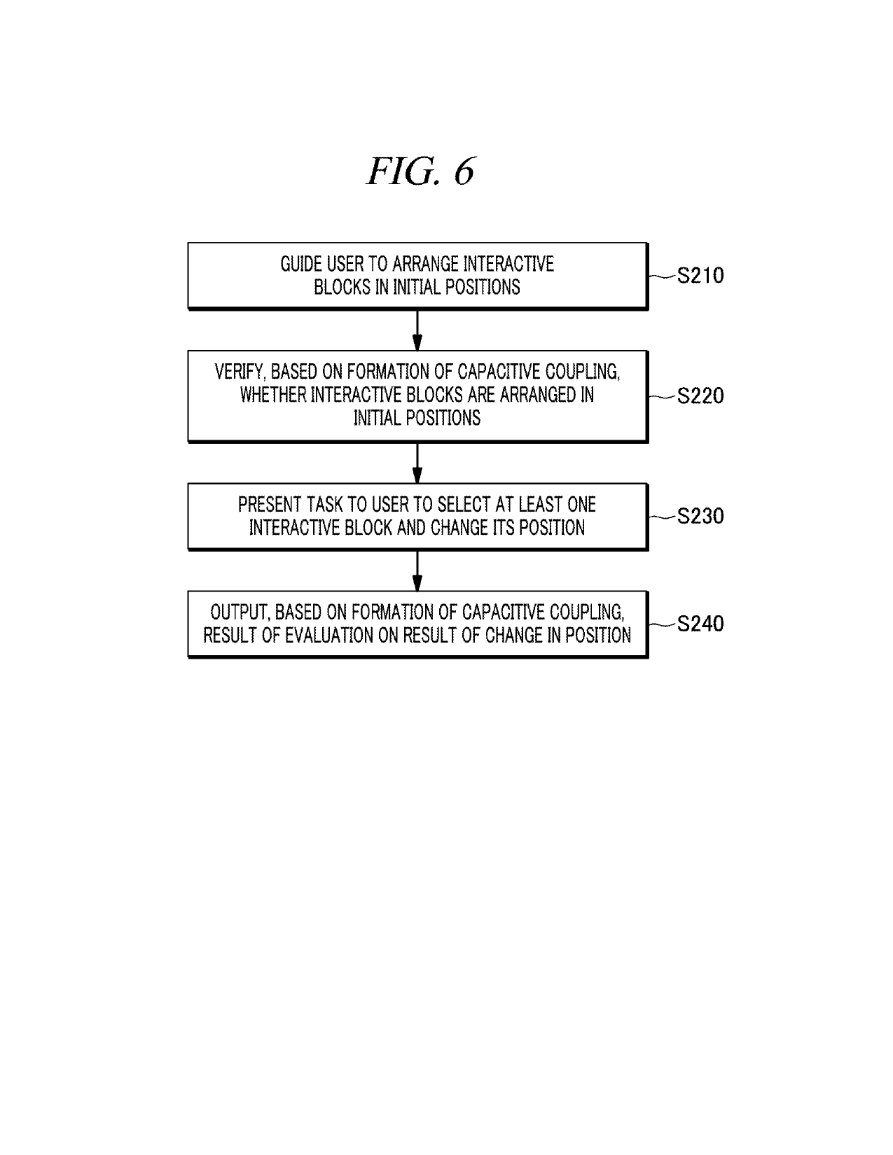

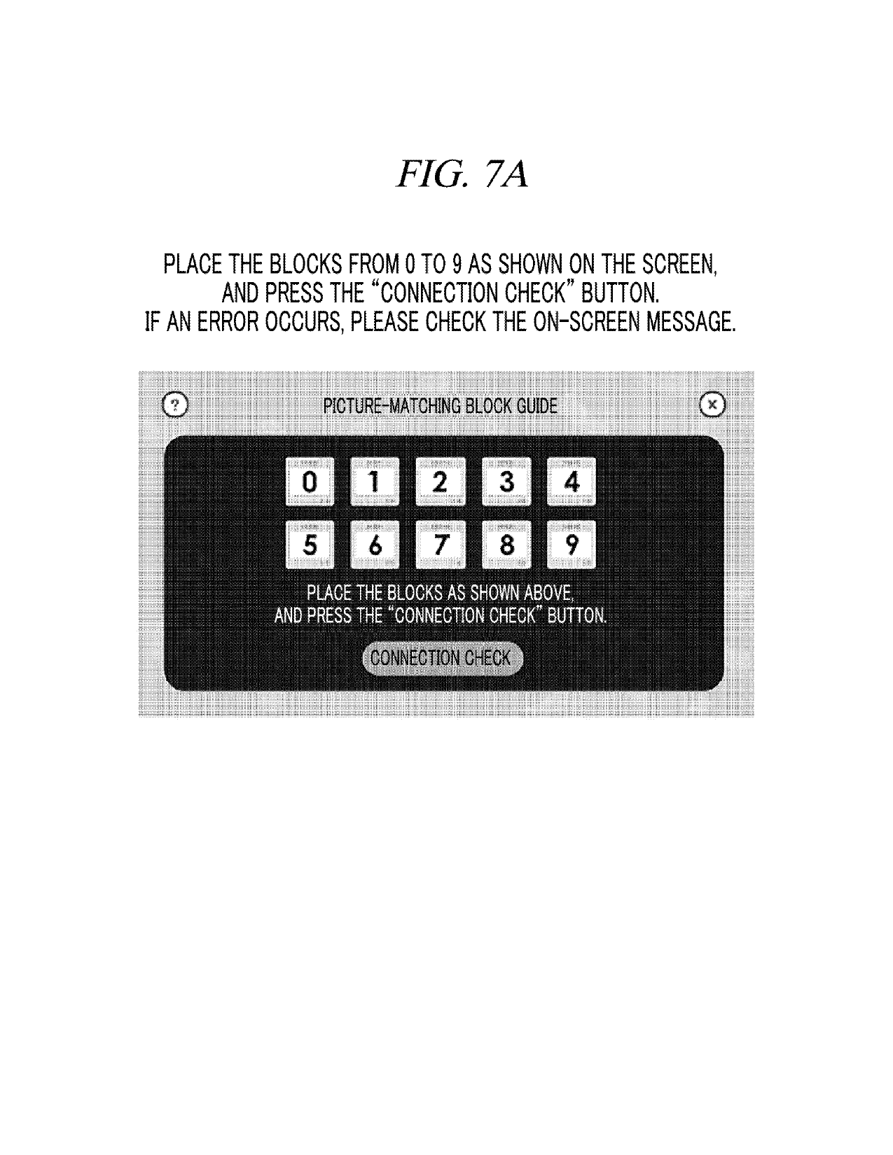

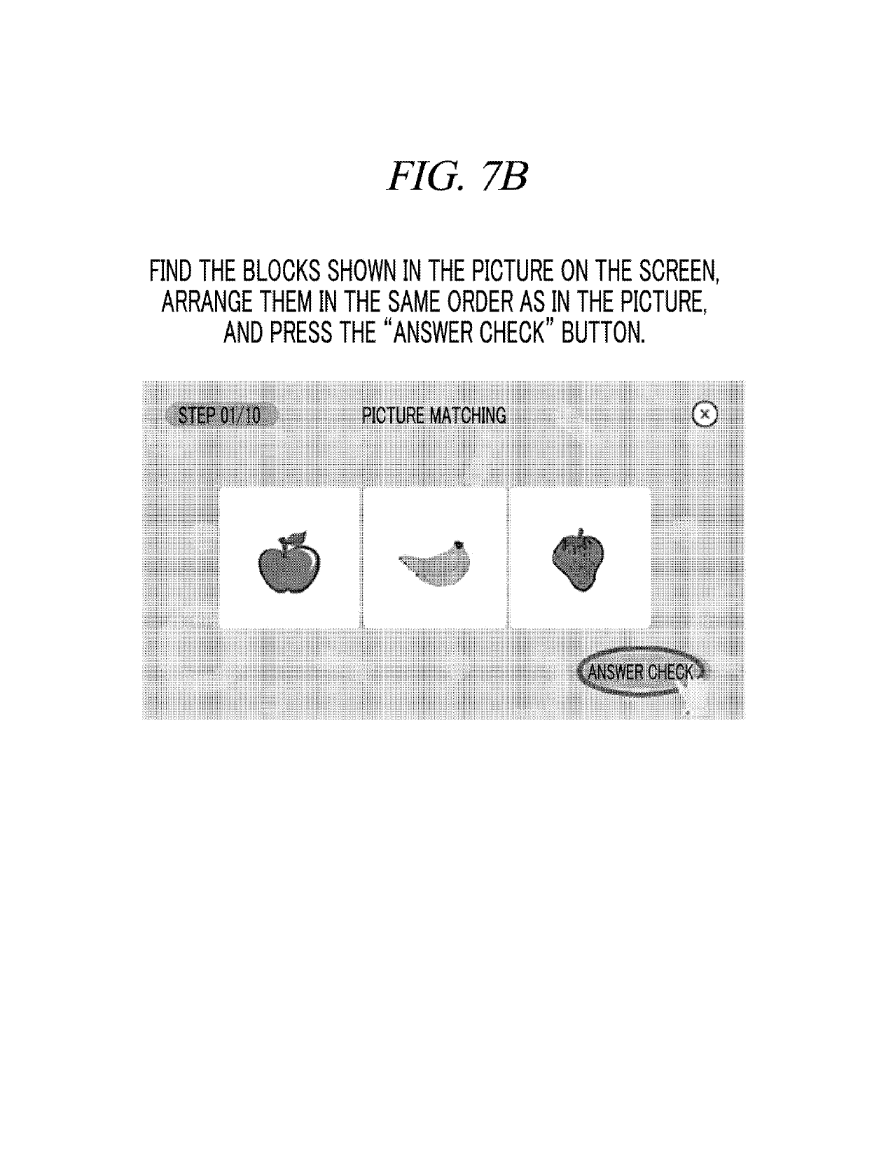

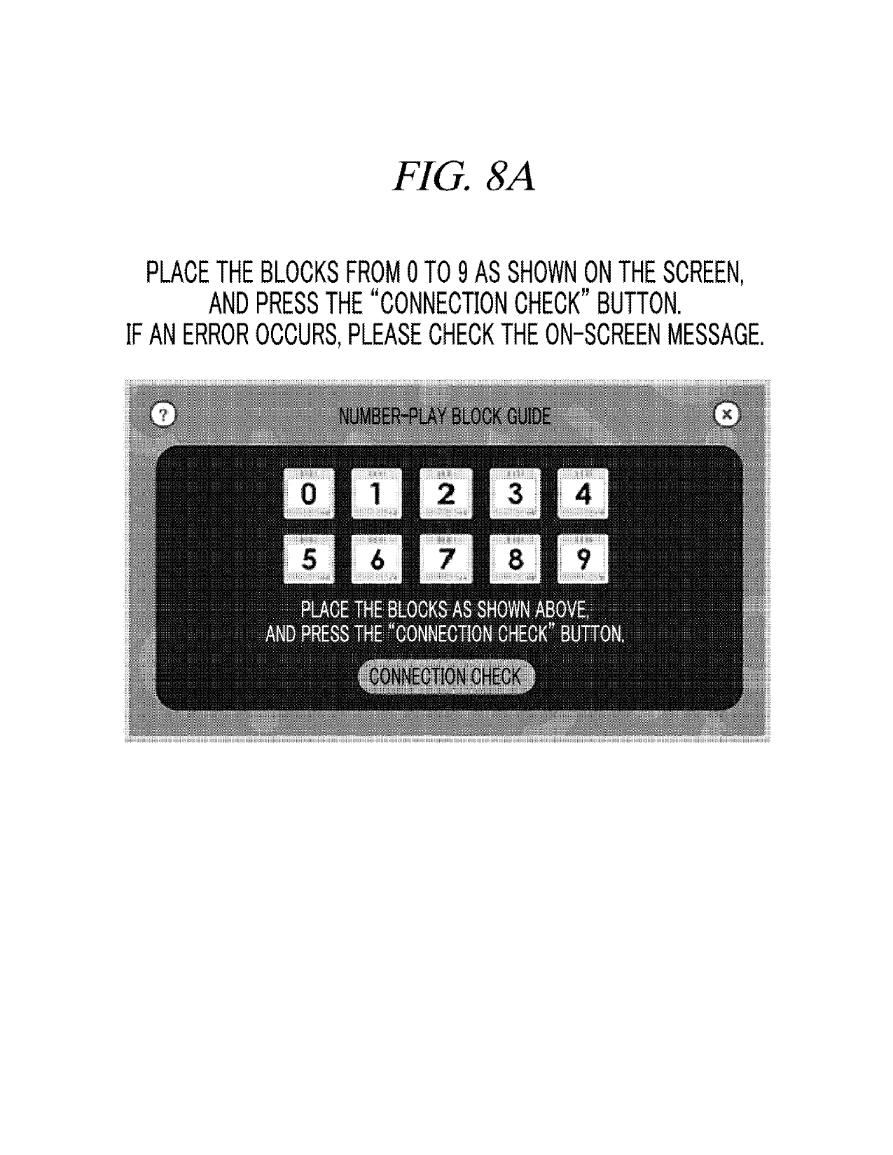

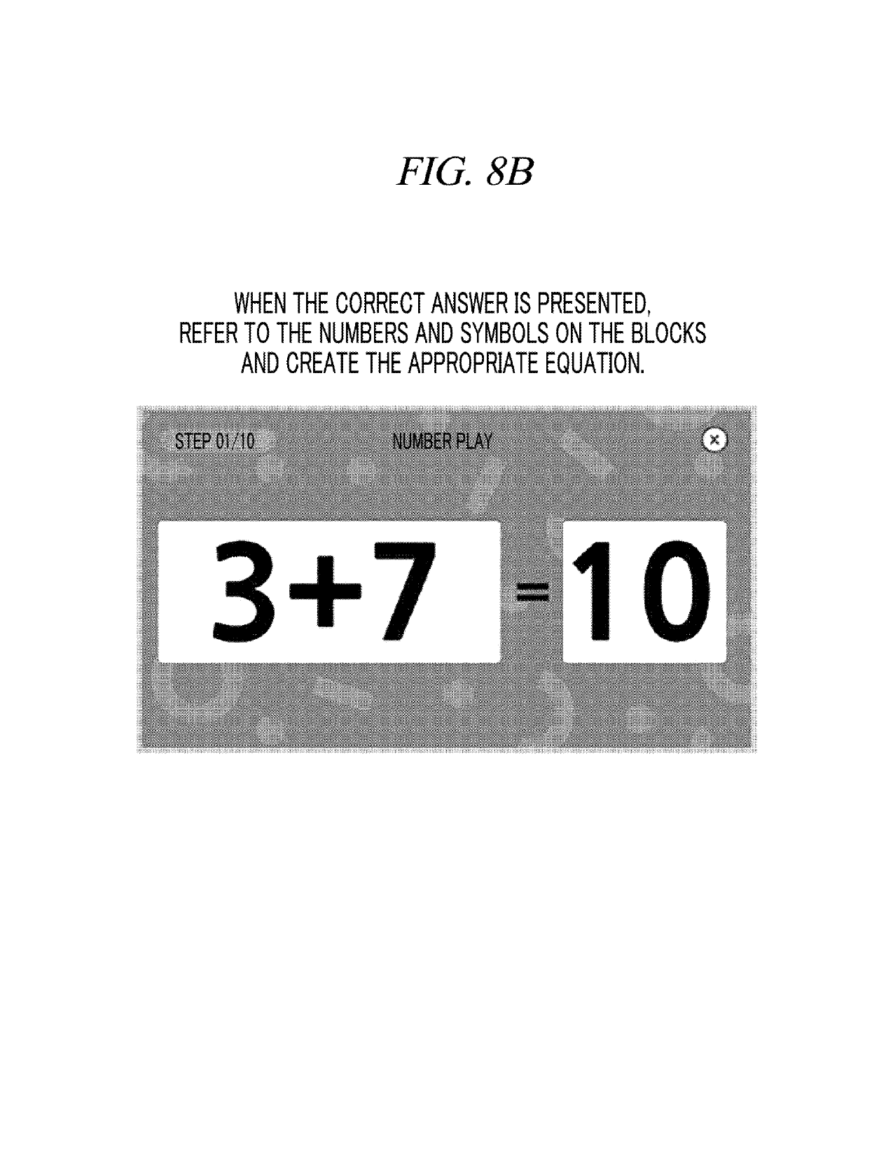

FIG. 6 is a flowchart showing a method for providing interactive content according to another embodiment of the present disclosure. FIG. 7A to FIG. 8B are exemplary diagrams of guidance screens showing processes of the method for providing interactive content according to yet another embodiment of the present disclosure.

Hereinafter, the method for providing interactive content according to another embodiment of the present disclosure will be described with reference to FIG. 6 to FIG. 8B. The method for providing interactive content of the present embodiment may be composed of guiding the user to manipulate or arrange the above-described plurality of interactive blocks and providing an evaluation of the result.

Each interactive block 120 performing the method for providing interactive content according to the present embodiment may include at least one of the sidewall part 121, the detachable coupling part 122, the electrode part 123, the controllers 124T and 124R, the detection unit 125, the display unit 126a, the light-emitting unit 126b, the speaker unit 127, the port 128, and the power switch 129 described in the above-described embodiment.

Referring to FIG. 6, the method for providing interactive content of the present embodiment includes: a process of guiding the user to arrange the plurality of interactive blocks in initial positions (S210); a process of verifying, based on the formation of capacitive coupling, whether the plurality of interactive blocks is arranged in the initial positions (S220); a process of presenting a task to the user to select at least one of the plurality of interactive blocks and change its position (S230); and a process of outputting, based on the formation of capacitive coupling, a result of evaluation on a result of the user’s change of position (S240).

In the process S210 of guiding the user to arrange the plurality of interactive blocks in initial positions, the initial positions of the plurality of interactive blocks 120 may be provided in at least one of visual and auditory forms. For example, guidance as shown in FIG. 7A may be output on a display device (such as a monitor) provided in hardware such as a computer or device linked or communicating with the plurality of interactive blocks 120.

Herein, the display unit 126a may be configured to output visual information indicating adjacency between interactive blocks 120. The visual information may include instructions for guiding the user to perform a manipulation, and a numeral, color, or image for specifying the interactive block 120 or distinguishing it from other interactive blocks 120. Specifically, as shown in FIG. 7A, the display units 126a of the interactive blocks 120 may each display different numerals or serial numbers.

When the user completes the arrangement of the interactive blocks 120 in the initial position (for example, by pressing “Connection Check” in FIG. 7A), the formation of capacitive coupling between adjacent ones of the plurality of interactive blocks 120 may be detected or interpreted. Accordingly, it may be verified whether the interactive blocks have been arranged in the initial positions as previously guided (S220).

Then, a task may be presented to the user (S230). In the present embodiment, the task may guide the user to select at least one interactive block 120 and change or rearrange its position. As shown in FIG. 7B, a task may be presented on the display device, instructing the user to select interactive blocks 120 bearing images displayed on the display device and arrange them in sequence.

In this case, the display unit 126a of each interactive block 120 may output visual information that differs from the information output in the process S210. In the present embodiment, unlike the numerals displayed in the process of FIG. 7A, images may be displayed on the display unit 126a in the process of FIG. 7B.

When the user selects and rearranges or arranges the interactive blocks 120 according to the task guidance (for example, when the user presses “Answer Check” in FIG. 7B), the formation of capacitive coupling between adjacent ones of the interactive blocks 120 may be detected or interpreted.

Referring to FIG. 7B, it may be verified whether, in each of three interactive blocks 120, a signal is received from the interactive block 120 that displays a correct image on the sidewall part 121 corresponding to the correct direction. The signal may include a unique ID of the interactive block 120 and an identification value of the adjacent surface. Based on the formation of capacitive coupling, an evaluation result may be output to indicate whether the user has correctly selected and arranged the interactive blocks (S240).

In yet another embodiment, content may be provided to create mathematical equations as shown in FIG . 8A and FIG. 8B. Specifically, as shown in FIG. 8A, the process of guiding the user to arrange the plurality of interactive blocks in initial positions may be performed (S210). Then, based on the formation of capacitive coupling, it may be verified whether the plurality of interactive blocks has been arranged in the initial positions (S220).

Thereafter, as shown in FIG. 8B, a task may be provided to guide the user to select at least one of the plurality of interactive blocks and change its position (S230). In this process, some interactive blocks 120 that previously displayed numerals may have their display units 126a changed to display symbols. When the user completes the arrangement in the order of equations, an evaluation result may be output based on the formation of capacitive coupling (S240).

According to the method for providing interactive content of the present disclosure, it is possible to variously implement cognitive, calculation, and manipulation training for users including elderly users by using detection results regarding coupling state or coupling direction between the interactive blocks 120. Also, the display unit 126a of the interactive block 120 can provide various images or the like that can be combined and arranged. Thus, new content can be continuously developed and provided.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An interactive block, comprising: at least one sidewall part; a detachable coupling part disposed within the sidewall part and configured to supply a coupling force allowing attachment to and detachment from another interactive block; and an electrode part disposed within the sidewall part and configured to form capacitive coupling using the sidewall part as a dielectric, in order to detect coupling with the other interactive block.

2. The interactive block of claim 1, wherein the electrode part includes: a transmission unit that transmits a square wave signal generated according to a predetermined protocol; and a reception unit that receives a triangular wave signal via capacitive coupling.

3. The interactive block of claim 2, further comprising: a detection unit configured to restore the triangular wave signal; and a controller configured to interpret the signal restored by the detection unit based on the predetermined protocol and to extract information regarding coupling with the other interactive block.

4. The interactive block of claim 3, wherein the detection unit restores the triangular wave signal to a square wave signal.

5. The interactive block of claim 2, wherein the square wave signal generated according to the predetermined protocol represents a unique identification number of the interactive block and an identification value of the sidewall part.

6. The interactive block of claim 1, further comprising: a display unit formed on at least a portion of an upper surface and configured to output visual information indicating information regarding coupling with another interactive block.

7. The interactive block of claim 6, wherein the display unit is configured to detect touch input from a user.

8. The interactive block of claim 1, further comprising: a motion sensor configured to detect at least one change in position and angle of the interactive block; and a vibration motor configured to generate vibrations to provide tactile information to the user.

9. The interactive block of claim 1, further comprising: a light-emitting unit formed along a corner portion between an upper surface and the sidewall part and configured to output visual information indicating a coupling state with the other interactive block.

10. The interactive block of claim 1, further comprising: a speaker unit configured to output voice information; and a power switch configured to be turned on or off by user manipulation.

11. An interactive device, comprising: a base; and a plurality of interactive blocks detachably attachable to the base, wherein each of the interactive blocks includes: at least one sidewall part; a detachable coupling part disposed within the sidewall part and configured to supply a coupling force allowing attachment to and detachment from another interactive block; and an electrode part disposed within the sidewall part and configured to form capacitive coupling using the sidewall part as a dielectric, in order to detect coupling with the other interactive block.

12. The interactive device of claim 11, wherein the base includes: a block mounting unit that supplies a coupling force allowing attachment to and detachment from the interactive block; and a power port connected to the interactive block mounted in the block mounting unit.

13. The interactive device of claim 12, wherein the interactive block further includes a port connected to the power port when it is mounted in the base.

14. A method for providing interactive content that uses a plurality of interactive blocks each including an electrode part disposed within a sidewall part and configured to form capacitive coupling using the sidewall part between the electrode parts as a dielectric when the interactive blocks are positioned adjacent to each other, the method comprising: a process of guiding a user to arrange the plurality of interactive blocks in initial positions; a process of verifying, based on the formation of capacitive coupling, whether the plurality of interactive blocks is arranged in the initial positions; a process of presenting a task to the user to select at least one of the plurality of interactive blocks and change its position; and a process of outputting, based on the formation of capacitive coupling, a result of evaluation on a result of the user’s change of position.

15. The method for providing interactive content of claim 14, wherein the interactive block further includes a display unit configured to output visual information indicating adjacency between the interactive blocks, and the display unit outputs different visual information in the process of guiding a user to arrange the plurality of interactive blocks in initial positions and in the process of presenting a task to the user to select at least one of the plurality of interactive blocks and change its position.
